(19) United States
(12) Patent Application Publication
(10) Pub. No.: US 2026/0085783 A1
(43) Pub. Date: Mar. 26, 2026

(54) WALL MOUNT STRUCTURE AND A METHOD THEREOF

(71) Applicant: Hand Held Products, Inc., Charlotte, NC (US)

(72) Inventors: Alvin WU, Charlotte, NC (US); Xia TIAN, Charlotte, NC (US); Jianming MAO, Charlotte, NC (US); Jerry HUANG, Charlotte, NC (US)

(21) Appl. No.: 19/329,043

(22) Filed: Sep. 15, 2025

(30) Foreign Application Priority Data
Sep. 24, 2024 (CN) 202411332891.0

(51) Int. Cl. F16M 13/02

(52) U.S. Cl. CPC F16M 13/02

(57) ABSTRACT

A wall mount structure comprises at least one aperture configured to receive at least one cylindrical protrusion and a plurality of retention members. Each retention member comprises a pocket with at least one spring disposed within each pocket, where the least one spring has a first end and a second end. At least one brake is disposed within each pocket of the plurality of retention members and has a first end and a second end which protrudes from the pocket into at least one aperture. Upon receiving the at least one cylindrical protrusion within the at least one aperture, the at least one brake is displaced from its rest position as the at least one cylindrical protrusion presses against the at least one brake and the at least one spring returns to its rest position and/or presses to form an interlock around the at least one cylindrical protrusion.

### CROSS REFERENCE TO RELATED APPLICATION

This application claims priority pursuant to 35 U.S.C. 119(a) to Chinese Application No. 202411332891.0, filed Sep. 24, 2024, which application is incorporated herein by reference in its entirety.

### TECHNOLOGICAL FIELD

Example embodiments of the present disclosure relate generally to a wall mount, and more particularly relates to a wall mount structure and a method thereof.

### BACKGROUND

Wall mounts provide a practical solution for organizing and securing mountable devices such as charging bases, phone holders, etc. to a surface so that a user can access the device associated with the mountable device. The improved accessibility of the mountable device enhances convenience and usability of the mountable device. Typically, the mountable devices are mounted on a wall surface through one or more techniques and enable a user to readily access a portable electronic device such as a phone, radio, or indicia reading device. The indicia reading device is designed to read and interpret various forms of indicia, such as barcodes, quick response (QR) codes, or other encoded information. The indicia reading device is equipped to scan and decode different types of encoded information. This includes traditional barcodes, QR codes, and other formats of machine-readable symbols, enabling the extraction and processing of data embedded within these codes. Such mountable devices can be affixed to the wall surface by securing a bracket on the wall surface using nails or other fasteners or can be hung or mounted directly onto the nail or other fastener. Such methods often require the use of an additional bracket to firmly hold the mountable devices in place, ensuing stability and durability over time. However, such techniques require careful alignment and measurement to ensure proper installation of the mountable devices and to prevent any potential damage to the wall surface and to position the mountable device in a position where a user can easily and readily access the device associated with the mountable device. Moreover, such mountable devices can be hung on a single nail or screw, offering a simpler and more reliable mounting option. However, while mounting the mountable devices on a nail or screw may simplify installation, there are chances that the mountable devices can be easily knocked off the nail, screw, or other fastener used to mount the mountable device to a wall surface. The mountable device can be knocked off the nail, screw, or other fastener if it experiences a force exerted in an upward direction, such as being inadvertently contacted by a user or during the placement of a device in or onto the mountable device, potentially causing the mountable devices, and/or their associated devices, to dislodge and fall. Therefore, proper installation techniques, including using appropriate hardware and ensuring sufficient weight-bearing capacity are essential to avoid such risks and ensure a safe and effective mounting of the mountable devices and their associated devices.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### SUMMARY

The following presents a summary of various embodiments of the invention to provide an understanding of aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In one example embodiment, a wall mount structure is disclosed. The wall mount structure comprises at least one aperture configured to receive at least one cylindrical protrusion. Further, the wall mount structure comprises a plurality of retention members arranged around a circumference of at least one aperture. Each of the plurality of retention members comprises a pocket with at least one spring disposed within each pocket where at least one spring has a first end coupled with a base of the pocket and a second end. Further, at least one brake is disposed within each pocket of the plurality of retention members and the at least one brake has a first end coupled with the second end of the at least one spring, and a second end which protrudes from the pocket into the at least one aperture. Thereafter, upon receiving the at least one cylindrical protrusion within the at least one aperture, the at least one brake of the plurality of retention members is displaced from its rest position as the at least one cylindrical protrusion presses against the at least one brake of the plurality of retention members and the at least one spring of at least one of the retention member of the plurality of retention members is caused by the at least one spring of the at least one retention member to return to its rest position and/or press against the cylindrical protrusion to form an interlock around the at least one cylindrical protrusion.

In some embodiments, at least one aperture has a compound shape and is a combination of geometrical features with at least a first portion and a second portion. Further, the first portion defines a radius of 6.0 mm and the second portion defines a radius of 3.0 mm.

In some embodiments, at least one brake is configured to laterally protrude from the circumference of the second portion of at least one aperture. In some embodiments, the at least one brake has a chamfered or relieved edge that causes the at least one brake to retract upon coming in contact with at least one cylindrical protrusion.

In some embodiments, the at least one brake is further configured to extend from the circumference of the second portion of the at least one aperture once a head portion of the at least one cylindrical protrusion inserts within the at least one aperture to interlock the at least one cylindrical protrusion with the wall mount structure.

In some embodiments, the second end of at least one brake comprises a tapered section. In some embodiments, the tapered section of at least one brake is configured to receive a shank portion of at least one cylindrical protrusion.

In some embodiments, the second end of at least one brake comprises a curved section. Further, the curved section is configured to accommodate the shank portion of at least one cylindrical protrusion.

In some embodiments, the wall mount structure further comprises a cover plate mounted along the at least one aperture. In some embodiments, the cover plate is configured to restrict further insertion of at least one cylindrical protrusion when interlocked by the wall mount structure.

In another example embodiment, a method is disclosed. The method comprising steps of receiving at least one cylindrical protrusion within at least one aperture of a wall mount structure. The method further comprises steps of arranging a plurality of retention members around a circumference of at least one aperture. Each of the plurality of retention members comprises a pocket with at least one spring disposed within each pocket, where at least one spring has a first end coupled with a base of the pocket, and a second end. Further, at least one brake disposed within each pocket of the plurality of retention members, and the at least one brake has a first end coupled with the second end of the at least one spring, and a second end which protrudes from the pocket into the at least one aperture. Thereafter, upon receiving the at least one cylindrical protrusion within the at least one aperture, the at least one brake of the plurality of retention members is displaced from its rest position as the at least one cylindrical protrusion presses against the at least one brake of the plurality of retention members and the at least one spring of at least one of the retention member the plurality of retention members is caused by the at least one spring of the at least one retention member to return to its rest position and/or press against the cylindrical protrusion to form an interlock around the at least one cylindrical protrusion.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a perspective view of a wall mount structure in accordance with an example embodiment of the present disclosure;

FIG. 2 illustrates a perspective view of the wall mount structure integrated within at least one wall mountable device in accordance with an example embodiment of the present disclosure; and,

FIGS. 3A-3B illustrate interlocking of at least one cylindrical protrusion by each of at least one brake in accordance with an example embodiment of the present disclosure.

### DETAILED DESCRIPTION OF THE INVENTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. As discussed herein, the protection devices may be referred to by humans but may also be used to raise and lower objects unless otherwise noted.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of a wall mount structure. Embodiments may comprise at least one aperture. The at least one aperture may be configured to receive at least one cylindrical protrusion. Embodiments may comprise a plurality of retention members arranged around a circumference of at least one aperture. Embodiments may comprise a pocket with at least one spring disposed within each pocket. At least one spring may have a first end that is coupled with a base of the pocket of the plurality of retention members. Further, at least one spring may comprise a second end. Embodiments may comprise at least one brake disposed with each pocket of the plurality of retention members. At least one brake may have a first end that is coupled with the second end of at least one spring. At least one brake may comprise a second end which protrudes from the pocket into at least one aperture. Embodiments may be configured to displace the at least one brake of the plurality of retention members displaced from its rest position as the at least one cylindrical protrusion presses against the at least one brake of the plurality of retention members and the at least one spring of at least one of the retention members of the plurality of retention members is caused by the at least one spring of the at least one retention member to return to its rest position and/or press against the cylindrical protrusion to form an interlock around the at least one cylindrical protrusion.

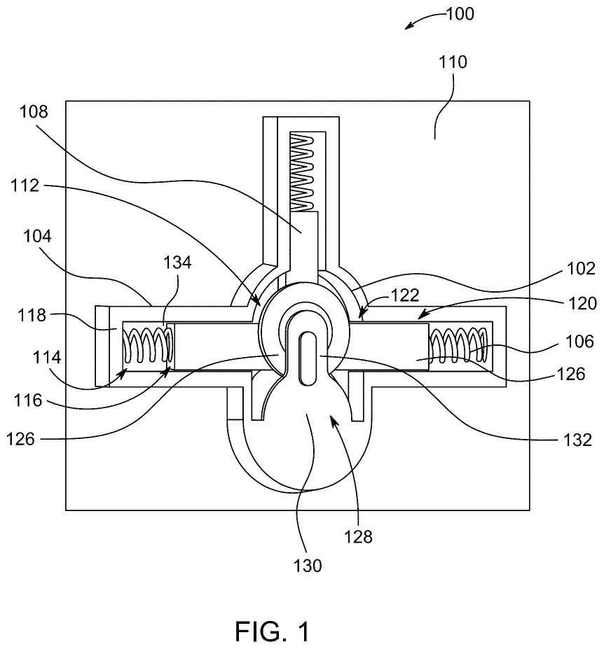

FIG. 1 illustrates a perspective view of a wall mount structure 100, in accordance with an example embodiment of the present disclosure. The wall mount structure 100 comprises at least one aperture 102 and a plurality of retention members 104.

In some embodiments, the wall mount structure 100 may be coupled with at least one wall mountable device 110. In at least one example, the wall mount structure 100 may be monolithically connected with the at least one wall mountable device 110. In another example, the wall mount structure 100 may be detachably coupled with at least one wall mountable device 110. In some embodiments, the wall mount structure 100 may be configured to ensure attachment of at least one wall mountable device 110 with a wall surface. In some embodiments, at least one wall mountable device 110 may be affixed to the wall surface by securing a bracket on the wall surface using nails or other fasteners or may be hung or mounted directly onto the nail or other fastener. At least one wall mountable device 110 may comprise at least one of such as a phone, radio, and indicia reading device. Further, the indicia reading device may be designed to read and interpret various forms of indicia, such as barcodes, quick response (QR) codes, or other encoded information. Further, the indicia reading device may be equipped to scan and decode different types of encoded information. Further, the encoded information may include traditional barcodes, QR codes, and other formats of machine-readable symbols, enabling the extraction and processing of data embedded within these codes. In some embodiments, the wall mount structure 100 may be composed of a material that may include but not limited to a metal, non-metal, etc. Further, the material of the wall mount structure 100 may be selected such that the wall mount structure 100 may remain durable.

In some embodiments, the wall mount structure 100 may comprise at least one aperture 102. In some embodiments, at least one aperture 102 may be configured to receive at least one cylindrical protrusion 112. Further, at least one aperture 102 may be crafted on the surface of the wall mount structure 100. In some embodiments, at least one aperture 102 may be constructed with one or more processes. In one example, one or more processes may correspond to a drilling process. In another example, the one or more processes may correspond to a molding process. In some embodiments, at least one aperture 102 may define a diameter of 12 mm.

In some embodiments, at least one cylindrical protrusion 112 may be imposed into the wall surface. Further, at least one cylindrical protrusion 112 may be configured to hold the wall mount structure 100 through the at least one aperture 102. Further, the at least one cylindrical protrusion 112 may comprise at least one of a screw or a nail. In some embodiments, at least one cylindrical protrusion 112 may be configured to engage into at least one aperture 102. In some embodiments, at least one cylindrical protrusion 112 may be composed of a material that comprises at least steel, aluminum, iron, etc. In some embodiments, the material of at least one cylindrical protrusion 112 may be selected to withstand weight of the wall mount structure 100.

In some embodiments, the wall mount structure 100 may comprise the plurality of retention members 104. Further, the plurality of retention members 104 may be arranged around circumference of at least one aperture 102. In some embodiments, each of the plurality of retention members 104 may be constructed with a shape that may include but not limited to a rectangular shape, a cylindrical shape etc. In some embodiments, the circumference of at least one aperture 102 may define a radius of circumference of 300 degrees. In one example, each of the plurality of retention members 104 may be positioned at a predefined angle (i.e., 90 degrees) from each other. In some embodiments, each of the plurality of retention members 104 may comprise a first portion and a second portion. Further, the first portion of each of the plurality of retention members 104 may be interconnected through at least one aperture 102.

In some embodiments, each of the plurality of retention members 104 may comprise a pocket 134. Further, the pocket 134 may be configured to define a cavity within each of the plurality of retention members 104. Further, the pocket 134 may define a length of 8.5 mm, a width of 3.0 mm, and a volume of 95.1 mm³. In some embodiments, the pocket 134 may be configured to accommodate the at least one spring 106. In some embodiments, the pocket 134 may be constructed within each of the plurality of retention members 104 may involve one or more machining processes such as drilling, cutting, and grinding.

In some embodiments, at least one spring 106 may be configured to compress and expand. In some embodiments, at least one spring 106 may be composed of a material that may include but is not limited to steel, iron, aluminum, etc. In some embodiments, at least one spring 106 may be disposed within each of the pocket 134 through one or more processes. Further, the one or more processes may comprise at least one of a hydraulic pressing, crimping, etc.

In some embodiments, each of the at least one spring 106 may comprise a first end 114 and a second end 116. In some embodiments, the first end 114 of at least one spring 106 may be coupled with a base 118 of the pocket 134 of the plurality of retention members 104. In some embodiments, the first end 114 of at least one spring 106 may correspond to a lower end. In some embodiments, at least one spring 106 may define a diameter of 2.8 mm. In some embodiments, each of at least one spring 106 may define a length range between 2.0 mm to 7.0 mm. In some embodiments, the at least one spring 106 may define the length of 2.7 mm when the at least one spring 106 may be compressed. In some embodiments, the at least one spring 106 may define the length of 5.5 mm when the at least one spring 106 may be expanded.

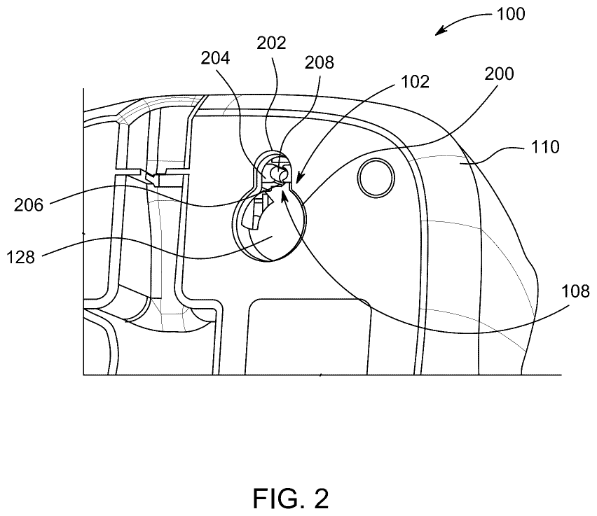

In some embodiments, the wall mount structure 100 may comprise at least one brake 108 disposed within each of the pocket 134 of the plurality of retention members 104. In some embodiments, at least one brake 108 from a plurality of brakes may be disposed with the pocket 134 of the plurality of retention members 104. In some embodiments, at least one brake 108 may be constructed with a shape that may include but not limited to cuboid, cylinder, etc. In some embodiments, each of the at least one brake 108 may be coupled with each of the at least one spring 106. In some embodiments, each of the at least one brake 108 may comprise a first portion 120 and a second portion 122. In some embodiments, the first portion 120 of each of the at least one brake 108 may comprise a first end 124 of at least one brake 108. Further, the second portion 122 of each of at least one brake 108 may comprise a second end 204 of the at least one brake 108 (FIG. 2).

In some embodiments, the first end 124 of each of at least one brake 108 may be coupled with the second end 116 of each of at least one spring 106. In one example, the at least one brake 108 may be attached with the at least one spring 106. In another example, at least one brake 108 may be detachably coupled with at least one spring 106. In some embodiments, each of the at least one spring 106 may be configured to compress and expand during a linear movement of each of the at least one brake 108. In some embodiments, the second end 204 of at least one brake 108 may be partially protruded from the circumference of at least one aperture 102.

In some embodiments, at least one aperture 102 may be configured to receive a head portion 126 of at least one cylindrical protrusion 112. Further, upon receiving at least one cylindrical protrusion 112 within the at least one aperture 102, each of the at least one brake 108 of the plurality of retention members 104 may be configured to displace from its rest position.

Further, the at least one cylindrical protrusion 112 may be pressed against the at least one brake 108 of the plurality of retention members 104 and the at least one spring 106 of at least one of the retention member of the plurality of retention members 104 may be caused by the at least one spring 106 of the at least one retention member to return to its rest position and/or may press against the at least one cylindrical protrusion 112 to form an interlock around the at least one cylindrical protrusion 112.

In some embodiments, the wall mount structure 100 may further comprise a cover plate 128. In some embodiments, the cover plate 128 may be configured to restrict further insertion of at least one cylindrical protrusion 112 into at least one aperture 102, when interlocked by the wall mount structure 100. In some embodiments, the cover plate 128 may be constructed with a shape that may include but not limited to a circle, rectangle, square, etc. In some embodiments, the cover plate 128 may be composed of a material that may comprise at least steel, aluminum, iron, etc. In one example, the cover plate 128 may be monolithic with at least one aperture 102. In another example, the cover plate 128 may be detachably coupled with at least one aperture 102. In some embodiments, the cover plate 128 may be configured to barricade the head portion 126 to the at least one cylindrical protrusion 112 to restrict further insertion of the at least one cylindrical protrusion 112 into the at least one aperture 102. In some embodiments, the cover plate 128 may be constructed coplanar to each of the plurality of retention members 104.

In some embodiments, the cover plate 128 may comprise a first section 130 and a second section 132. Further, the first section 130 of the cover plate 128 may be monolithic with the circumference of at least one aperture 102. Further, the second section 132 of the cover plate 128 may be configured to barricade the head portion 126 of at least one cylindrical protrusion 112. In some embodiments, the first section 130 of the cover plate 128 and the second section 132 of the cover plate 128 have a predefined width. In some embodiments, width of the first section 130 of the cover plate 128 may be greater than width of the second section 132 of the cover plate 128 (as illustrated in FIG. 1).

FIG. 2 illustrates a perspective view of the wall mount structure 100 integrated within the at least one wall mountable device 110, in accordance with an example embodiment of the present disclosure.

In some embodiments, at least one aperture 102 may comprise a first portion 200 and a second portion 202. In some embodiments, at least one aperture 102 may have a compound shape and may be a combination of geometrical features with at least the first portion 200 and a second portion 202. Further, the first portion 200 of at least one aperture 102 may define a radius of 6.0 mm. Further, the second portion 202 of at least one aperture 102 may define a radius of 3.0 mm. Further, the at least one brake 108 of each of the plurality of brakes may be configured to laterally protrude from the circumference of the second portion 202 of the at least one aperture 102. In some embodiments, the first portion 200 of at least one aperture 102 may be configured to receive at least one cylindrical protrusion 112. Further, at least one cylindrical protrusion 112 may be configured to slide from the first portion 200 to the second portion 202 to interlock with the wall mount structure 100 through each of the plurality of brakes.

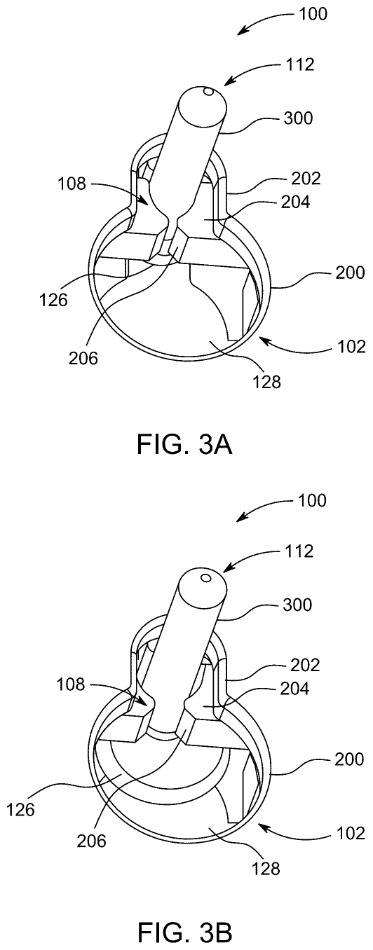

As illustrated in FIG. 2, the second end 204 of each of at least one brake 108 may correspond to the portion that may be protruded into the circumference of at least one aperture 102. In some embodiments, the second end 204 of each of at least one brake 108 may comprise a tapered section 206. In some embodiments, the tapered section 206 of each of at least one brake 108 may be configured to receive a shank portion 300 (FIGS. 3A and 3B) of at least one cylindrical protrusion 112. In some embodiments, the shank portion 300 of at least one cylindrical protrusion 112 may define a diameter of 3.0 mm. Further, the tapered section 206 of the second end 204 of each of at least one brake 108 may be configured to clamp the shank portion 300 of at least one portion. In some embodiments, the second end 204 of each of at least one brake 108 may be formed with a curved section 208. Further, the curved section 208 of each of at least one brake 108 may be configured to clamp the shank portion 300 of at least one cylindrical protrusion 112.

In some embodiments, each of at least one brake 108 may comprise a chamfered or relieved edge. Further, the chamfered or relieved edge of each of at least one brake 108 may cause at least one brake 108 to retract upon coming in contact with the head portion 126 of the at least one cylindrical protrusion 112. Further, each of the at least one brake 108 unit may be configured to extend once the head portion 126 of the at least one cylindrical protrusion 112 further inserts within the at least one aperture 102 to interlock the at least one cylindrical protrusion 112 with the wall mount structure 100. In some embodiments, each of at least one spring 106 may be configured to release the potential energy that may be generated during retraction of each of the at least one brake 108. In some embodiments, each of the at least one brake 108 may be configured to apply an appropriate force on the shank portion 300 of the at least one cylindrical protrusion 112 during the extension of each of the at least one brake 108.

FIGS. 3A-3B illustrate interlocking of at least one cylindrical protrusion 112 by each of the at least one brake 108, in accordance with an example embodiment of the present disclosure.

In some embodiments, the wall mount structure 100 may comprise the plurality of retention members 104. Further, each of the plurality of retention members 104 may be disposed with at least one spring 106. Further, each of the plurality of retention members 104 may comprise at least one brake 108. Further, each of at least one brake 108 may comprise the first end 124 and the second end 204. In some embodiments, the first end 124 of each of at least one brake 108 may be coupled with each of at least one spring 106. Further, the wall mount structure 100 may comprise at least one aperture 102. Further, at least one aperture 102 may comprise the first portion 200 and the second portion. Further, the first portion 200 of the at least one aperture 102 may be configured to receive at least one cylindrical protrusion 112. Further, at least one cylindrical protrusion 112 may be configured to slide from the first portion 200 to the second portion.

In some embodiments, the second end 204 of each the at least one brake 108 may comprise the tapered section 206. Further, the tapered section 206 of each of at least one brake 108 may be configured to receive the shank portion 300 of at least one cylindrical protrusion 112. Further, each of the at least one brake 108 may be configured to displace from its rest position upon receiving at least one cylindrical protrusion 112 into the second portion. Further, each of the at least one spring 106 may be configured to store the potential energy during sliding of at least one cylindrical protrusion 112 from the first portion 200 to the second portion. Further, each of the at least one brake 108 may be configured to extend once the head portion 126 of the at least one cylindrical protrusion 112 inserts within the second portion 202 of the at least one aperture 102 to interlock the at least one cylindrical protrusion 112 with the wall mount structure 100.

In one example, each of the at least one brake 108 may be configured to extend up to a length of 2.5 mm. In some embodiments, the second end 204 of each of at least one brake 108 may comprise the tapered section 206. Further, the tapered section 206 of the second end 204 of each of at least one brake 108 may be configured to receive the shank portion 300 of the at least one cylindrical protrusion 112. In one example, the shank portion 300 of at least one cylindrical protrusion 112 may be configured to define a radius of curvature of 1.5 mm (as illustrated in FIG. 3A). In another example, each of the at least one brake 108 may be configured to extend up to a length of 2.5 mm. Further, the tapered section 206 of the second end 204 of each of at least one brake 108 may be configured to receive the shank portion 300 of the at least one cylindrical protrusion 112. In another example, the shank portion 300 of at least one cylindrical protrusion 112 may be configured to define a radius of curvature of 5 mm (as illustrated in FIG. 3B).

In some embodiments, a method for the wall mount structure 100 is disclosed. Further, the method comprises one or more steps. Firstly, at least one aperture 102 of the wall mount structure 100 may be configured to receive at least one cylindrical protrusion 112. In some embodiments, the wall mount structure 100 further comprises the plurality of retention members 104. Successively, each of the plurality of retention members 104 may be arranged around the circumference of at least one aperture 102. Further, each of the plurality of retention members 104 may comprise the pocket 134. Further, the pocket 134 may be disposed with at least one spring 106. Further, each of the at least one spring 106 may have the first end 114 and the second end 116. In some embodiments, the first end 114 of each of at least one spring 106 may be coupled with the base 118 of the pockets of each of the plurality of retention members 104.

In some embodiments, the wall mount structure 100 further comprises at least one brake 108. Further, at least one brake 108 may be disposed within the pocket 134 of the plurality of retention members 104. Further, each of the at least one brake 108 may have the first end 124 and the second end 204. Further, the first end 124 of each of the at least one brake 108 may be coupled with the second end 116 of the at least one spring 106. Further, the second end 204 of each of at least one brake 108 may be protruded from the circumference of at least one aperture 102. In some embodiments, upon receiving at least one cylindrical protrusion 112 within the at least one aperture 102, each of the at least one brake 108 of the plurality of retention members 104 may be configured to displace from its rest position. Further, the at least one cylindrical protrusion 112 may be pressed against the at least one brake 108 of the plurality of retention members 104 and the at least one spring 106 of at least one of the retention member of the plurality of retention members 104 may be caused by the at least one spring 106 of the at least one retention member to return to its rest position and/or may press against the at least one cylindrical protrusion 112 to form an interlock around the at least one cylindrical protrusion 112.

The present disclosure provides various embodiments of the wall mount structure 100. Embodiments may be configured to hold at least one cylindrical protrusion 112 firmly at its place. Embodiments may be configured to receive at least one cylindrical protrusion 112 of various sizes. Embodiments may be configured to secure the wall mount structure 100 with the wall surface through at least one aperture 102. Embodiments may be configured to attain a tight grip over the at least one cylindrical protrusion 112 through an extension and retraction of each of the at least one brake 108 via each of the at least one spring 106.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A wall mount structure comprising:
at least one aperture configured to receive at least one cylindrical protrusion; and
a plurality of retention members are arranged around a circumference of the at least one aperture, wherein each of the plurality of retention members comprises:
a pocket with at least one spring disposed within each pocket, wherein the at least one spring has:
a first end coupled with a base of the pocket; and
a second end;
at least one brake disposed within each pocket of the plurality of retention members, wherein the at least one brake has:
a first end coupled with the second end of the at least one spring; and,
a second end which protrudes from the pocket into the at least one aperture, wherein upon receiving the at least one cylindrical protrusion within the at least one aperture, the at least one brake of the plurality of retention members is displaced from its rest position as the at least one cylindrical protrusion presses against the at least one brake of the plurality of retention members and the at least one spring of at least one of the retention member of the plurality of retention members is caused by the at least one spring of the at least one retention member to return to its rest position and/or press against the cylindrical protrusion to form an interlock around the at least one cylindrical protrusion.

2. The wall mount structure of claim 1, wherein the at least one aperture has a compound shape and is a combination of geometrical features with at least a first portion and a second portion, wherein the first portion defines a radius of 6.0 mm and the second portion defines a radius of 3.0 mm.

3. The wall mount structure of claim 2, wherein the at least one brake is configured to laterally protrude from the circumference of the second portion of the at least one aperture.

4. The wall mount structure of claim 1, wherein the at least one brake has a chamfered or relieved edge that causes the at least one brake to retract upon coming in contact with the at least one cylindrical protrusion.

5. The wall mount structure of claim 3, wherein the at least one brake is further configured to extend from the circumference of the second portion of the at least one aperture once a head portion of the at least one cylindrical protrusion inserts within the at least one aperture to interlock the at least one cylindrical protrusion with the wall mount structure.

6. The wall mount structure of claim 1, wherein the second end of the at least one brake comprises a tapered section.

7. The wall mount structure of claim 6, wherein the tapered section of the at least one brake is configured to receive a shank portion of the at least one cylindrical protrusion.

8. The wall mount structure of claim 7, wherein the second end of the at least one brake comprises a curved section, wherein the curved section is configured to clamp the shank portion of the at least one cylindrical protrusion.

9. The wall mount structure of claim 1, further comprising a cover plate mounted along the at least one aperture.

10. The wall mount structure of claim 9, wherein the cover plate is configured to restrict further insertion of the at least one cylindrical protrusion when interlocked by the wall mount structure.

11. A method comprising:
receiving at least one cylindrical protrusion within at least one aperture of a wall mount structure;
arranging a plurality of retention members around a circumference of the at least one aperture, wherein each of the plurality of retention members comprises:
a pocket with at least one spring disposed within pocket, wherein the at least one spring having:
a first end coupled with a base of the pocket; and
a second end;
at least one brake disposed within each pocket of the plurality of retention members, wherein the at least one brake has:
a first end coupled with the second end of the at least one spring; and,
a second end which protrudes from the pocket into the at least one aperture, wherein upon receiving the at least one cylindrical protrusion within the at least one aperture, the at least one brake of the plurality of retention members is displaced from its rest position as the at least one cylindrical protrusion presses against the at least one brake of the plurality of retention members and the at least one spring of at least one of the retention member of the plurality of retention members is caused by the at least one spring of the at least one retention member to return to its rest position and/or press against the cylindrical protrusion to form an interlock around the at least one cylindrical protrusion.

12. The method of claim 11, wherein the at least one aperture has a compound shape and is a combination of geometrical features with at least a first portion and a second portion, wherein the first portion defines a radius of 6.0 mm and the second portion defines a radius of 3.0 mm.

13. The method of claim 12, wherein the at least one brake is configured to laterally protrude from the circumference of the second portion of the at least one aperture.

14. The method of claim 11, wherein the at least one brake has a chamfered or relieved edge that causes the at least one brake to retract upon coming in contact with the at least one cylindrical protrusion.

15. The method of claim 13, wherein the at least one brake is further configured to extend from the circumference of the second portion of the at least one aperture once a head portion of the at least one cylindrical protrusion inserts within the at least one aperture to interlock the at least one cylindrical protrusion with the wall mount structure.

16. The method of claim 11, wherein the second end of the at least one brake comprises a tapered section.

17. The method of claim 16, wherein the tapered section of the at least one brake is configured to receive a shank portion of the at least one cylindrical protrusion.

18. The method of claim 17, wherein the second end of the at least one brake comprises a curved section, wherein the curved section is configured to accommodate the shank portion of the at least one cylindrical protrusion.

19. The method of claim 11, further comprising a cover plate mounted along the at least one aperture.

20. The method of claim 19, wherein the cover plate is configured to restrict further insertion of the at least one cylindrical protrusion when interlocked by the wall mount structure.
